(19) United States
(12) Patent Application Publication
(10) Pub. No.: US 2026/0135345 A1
(43) Pub. Date: May 14, 2026

(54) PRASEODYMIUM OPTICAL FIBER

(71) Applicant: KING FAHD UNIVERSITY OF PETROLEUM AND MINERALS, Dhahran (SA)

(72) Inventors: Khurram Karim QURESHI, Dhahran (SA); Jawad AHMAD, Dhahran (SA); Salman GHAFOOR, Dhahran (SA)

(73) Assignee: KING FAHD UNIVERSITY OF PETROLEUM AND MINERALS, Dhahran (SA)

(21) Appl. No.: 19/437,905

(22) Filed: Dec. 31, 2025

Related U.S. Application Data
(62) Division of application No. 17/953,849, filed on Sep. 27, 2022.

(51) Int. Cl. H01S 3/067; H01S 3/00; H01S 3/094; H01S 3/13; H01S 3/16

(52) U.S. Cl. CPC H01S 3/06716; H01S 3/0064; H01S 3/094003; H01S 3/13013; H01S 3/1613

(57) ABSTRACT

An optical signal amplifier using a praseodymium doped fiber is described. The optical signal amplifier includes a signal laser, a first optical isolator, a second optical isolator a pump laser, a wave division multiplexer, a silica based glass optical fiber, a second optical isolator, an optical power meter, and an optical spectrum analyzer (OSA). The signal laser generates a signal laser beam. The pump laser generates a pumped laser beam. The wave division multiplexer combines the signal laser beam and the pumped laser beam and generates a combined laser beam. The silica based glass optical fiber has a preferred concentration of praseodymium ions of about 50×10²⁴ ions/m³ and a length of about 5.7 m. The silica based glass optical fiber receives the combined laser beam, amplifies photons in the combined laser beam, and generates an amplified laser beam.

### STATEMENT REGARDING PRIOR DISCLOSURE BY THE INVENTORS

Aspects of this technology are described in an article “Performance evaluation of praseodymium doped fiber amplifiers”, published in Optical Review 28, 611-618 on Oct. 13, 2021, which is incorporated herein by reference in its entirety.

### BACKGROUND

### Technical Field

The present disclosure is directed to a praseodymium doped fiber amplifier.

### Description of Related Art

The “background” description provided herein is for the purpose of generally presenting the context of the disclosure. Work of the presently named inventors, to the extent it is described in this background section, as well as aspects of the description which, may not otherwise qualify as prior art at the time of filing, are neither expressly or impliedly admitted as prior art against the present invention.

The number of internet users as well as the use of various high bandwidth applications such as voice over IP, video conferencing, online gaming, high definition video streaming, and social networking is increasing. Due to intensified Internet usage and demand for network capacity, optical fiber networks and wavelength-division multiplexing (WDM) networks have increased over the past few years. WDM networks may have multiple add-drop sites from where certain wavelengths are dropped and added simultaneously using optical add-drop multiplexing components, resulting in optical attenuation of optical signals. Additionally, the optical signals are further attenuated when transmitted over longer distances. The attenuations are compensated, and optical power is restored by incorporating optical amplifiers.

An optical amplifier is a device that amplifies the optical signal directly, without the need to first convert it to an electrical signal. Some examples of the optical amplifier include, but are not limited to, semiconductor optical amplifiers (SOA), Fiber Raman and Brillouin optical amplifiers and rare earth doped fiber optical amplifiers. In the rare earth doped fiber optical amplifier, stimulated emission in the amplifier's gain medium causes amplification of incoming light (optical signal). The rare earth doped fiber optical amplifier amplifies the signal in the optical domain as well as provides a high gain to multiple optical wavelengths simultaneously. In the fabrication of rare earth doped fiber optical amplifiers, rare-earth dopants such as erbium, thulium, praseodymium, and ytterbium are used. Although most commonly used, the erbium-doped fiber amplifier is prone to many disadvantages such as fixed gain range, optical surge problem and high pump power consumption. Due to these disadvantages, an erbium-doped fiber amplifier cannot be integrated effectively with other semiconductor devices.

Generally, optical communication systems operate in 1.5 μm and 1.3 μm wavelength regions where the optical fiber exhibits low attenuation. Currently the 1.5 μm window is facing its capacity limits. An opening of a new window is highly desirable to accommodate the exponential growth in demand for transmission bandwidth. Therefore, a 1.3 μm window has been widely explored by system designers of optical communication systems owing to zero dispersion and low scattering and absorption losses. Praseodymium doped fiber amplifiers (PDFAs) are commercially available for amplification in the O-band (1260 nm-1360 nm) and are compatible with the 1.3 μm optical window. In particular, undesirable distortion effects such as cross-gain modulation and pattern dependence are eliminated in the PDFA as a result of its high saturation energy and slow gain dynamics. PDFAs are now widely used in data center networks (DCNs), metro networks, and access networks (various passive optical network (PON) systems) as booster as well as in-line amplifiers. An existing Pr³⁺ doped chalcogenide photonic crystal fiber (PCF) design has a slope efficiency of 64% at 4500 nm for fiber loss of 1 dB/m (See: M. A. Khamis, R. Sevilla, K. Ennser, “Large Mode Area Pr³⁺-Doped Chalcogenide PCF Design for High Efficiency Mid-IR Laser”, IEEE, incorporated herein by reference in its entirety). An existing Pr³⁺ based co-doped fiber amplifier has a gain performance of 20 dB (See: Jiang, C., “Modeling and gain properties of Er³⁺ and Pr³⁺codoped fiber amplifier for 1.3 and 1.5 μm windows,” J. Opt. Soc. Am. B 26, 1049-1056 (2009), incorporated herein by reference in its entirety). A conventional design of PDFA operating around 1.3 μm has a gain performance of 20.4 dB (See: Schimmel, R. C., van de Sluis, H. J. D., Jonker, R. J. W., & Waardt, de, H. (2001), “Characterisation and modelling of praseodymium doped fibre amplifiers,” proceedings of the 6th annual symposium of the IEEE/LEOS Benelux Chapter, Dec. 2, 2001, Brussels, Belgium (pp. 133-136). IEEE/LEOS, incorporated herein by reference in its entirety). A conventional design of PDFA operating around 1.3 μm has a gain performance of 15 dB (See: Chorchos, Lukasz & Turkiewicz, Jaroslaw. (2017), “Experimental performance of semiconductor optical amplifiers and praseodymium-doped fiber amplifiers in 1310-nm dense wavelength division multiplexing system,” Optical Engineering. 56. 046101, 10.1117/1.OE.56.4.046101, incorporated herein by reference in its entirety). A praseodymium-doped fiber amplifier with a noise figure of 6.5 and a gain of 30 dB was described (See: Nishida, Y., Yamada, M., Kanamori, T., Kobayashi, K., Temmyo, J., Sudo, S., Ohishi, Y.: Development of an efficient praseodymium-doped fiber amplifier. IEEE J. Quantum Electron. 34(8), 1332-1339 (1998), incorporated herein by reference in its entirety). However, the systems and methods described in these references and other conventional systems suffer from various limitations including various distortion effects typically associated with the saturation mechanism and gain dynamics of the amplifier.

Hence, there is a need for an optical signal amplifier which has a wider operating bandwidth, a low loss window, and improved compatibility with wavelength division multiplexed systems.

### SUMMARY

In a embodiment, an optical signal amplifier is described. The optical signal amplifier includes a signal laser configured to generate a signal laser beam of wavelength about 1.3 μm, a first optical isolator connected to the signal laser, a pump laser configured to generate a pumped laser beam of about 1.03 μm at a pumped power of about 300 mW, a wave division multiplexer connected to the first optical isolator and the pump laser, wherein the wave division multiplexer is configured to combine the signal laser beam and the pumped laser beam and generate a combined laser beam, a silica based glass optical fiber having a concentration of praseodymium ions in a doped inner layer of about 50×10²⁴ ions/m³, wherein the silica based glass optical fiber is configured to receive the combined laser beam, amplify photons in the combined laser beam, and generate an amplified laser beam, a second optical isolator configured to receive the amplified laser beam, an optical power meter connected to the optical isolator, wherein the optical power meter is configured to measure an amplitude of the amplified laser beam, and an optical spectrum analyzer (OSA) connected to the optical isolator, wherein the OSA is configured to measure a frequency response of the amplified laser beam.

In another exemplary embodiment, a praseodymium doped fiber is described. The praseodymium doped fiber includes a silica based glass optical fiber having a length selected from the range of 15 m to 16 m, a core radius of about 1.2 μm, and a doped inner layer, wherein a concentration of praseodymium Pr³⁺ ions in the doped inner layer is about 50×10²⁴ ions/m³.

In another exemplary embodiment, a method of designing the optical signal amplifier is described. The method includes selecting a first length of a praseodymium (Pr³⁺) doped silica based fiber having a first Pr³⁺ ion concentration. The method further includes performing the steps of: injecting the Pr³⁺ doped silica based fiber with a combined laser beam consisting of a pump laser beam and a signal laser beam, exciting the Pr³⁺ ions with the combined laser beam, releasing, from the excited Pr³⁺ ions, an amount of supplemental photons which amplify the combined laser beam, generating an amplified laser beam at an output of the Pr³⁺ doped silica based fiber, measuring, with an optical power meter connected to the output of the Pr³⁺ doped silica based fiber, an amplitude of the amplified laser beam, measuring, with an optical spectrum analyzer (OSA) connected to the Pr³⁺ doped silica based fiber, a frequency response of the amplified laser beam. The method further includes calculating, with a computing device connected to the optical power meter and the OSA, a first noise figure and a first gain of the optical signal amplifier having the first length. The method further includes storing, in a memory of the computing device, the first noise figure and the first gain with the first length. The method further includes replacing the first length of Pr³⁺ doped silica based fiber with a second length of Pr³⁺ doped silica based fiber, wherein the second length is greater than the first length; and repeating the steps. The method further includes calculating, with the computing device, a second noise figure and a second gain of the optical signal amplifier having the second length and storing, in the memory, the second noise figure and a second gain with the second length. The method further includes repeating the steps for successive lengths of Pr³⁺ doped silica based fibers until a current gain decreases with respect to a directly previous gain and a current noise figure increases with respect to a directly previous noise figure. The method further includes comparing, by the computing device, the successive lengths to determine a length which generates a first maximum gain of the signal laser beam. The method further includes varying a praseodymium doping concentration of the praseodymium doped silica based fiber having the length which generates the first maximum gain of the signal laser beam. The method further includes injecting the optical signal amplifier with the combined pump laser beam and signal laser beam for each praseodymium doping concentration. The method further includes determining the praseodymium doping concentration which generates a second maximum gain of the signal laser beam. The method further includes installing the length of praseodymium doped silica based fiber having the second maximum gain of the signal laser beam in the optical signal amplifier.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a praseodymium doped fiber amplifier (PDFA), according to aspects of the present disclosure;

FIG. 2A is a graph illustrating gain versus praseodymium doped fiber (PDF) length at different pump powers, according to aspects of the present disclosure;

FIG. 2B is a graph illustrating the effect of different Pr³⁺ ion concentrations on gain of the PDFA, according to aspects of the present disclosure;

FIG. 3A is a graph of pump power versus output power at different signal powers, according to aspects of the present disclosure;

FIG. 3B is a graph illustrating pump wavelength versus output power for an input signal power of 0 dBm at different pump powers, according to aspects of the present disclosure;

FIG. 4A is a graph illustrating an amplified spontaneous emission (ASE) ASE power versus input signal wavelength as a function of pump power, according to aspects of the present disclosure;

FIG. 4B is a graph illustrating gain versus output power as a function of pump power, according to aspects of the present disclosure;

FIG. 5A is a graph illustrating gain versus pump power at optimized parameters, according to aspects of the present disclosure;

FIG. 5B is a graph illustrating gain versus input signal power as a function of pump power at optimized parameters, according to aspects of the present disclosure;

FIG. 6A is a graph illustrating noise figure (NF) versus input signal wavelength at different signal powers, according to aspects of the present disclosure;

FIG. 6B is a graph illustrating NF versus pump power at different signal powers, according to aspects of the present disclosure;

FIG. 7 is an illustration of a non-limiting example of details of computing hardware used in the computing device, according to aspects of the present disclosure;

FIG. 8 is a schematic diagram of a data processing system used within the computing device, according to aspects of the present disclosure;

FIG. 9 is a schematic diagram of a processor used with the computing device, according to aspects of the present disclosure; and

FIG. 10 is an illustration of a non-limiting example of distributed components that may share processing with the controller 700 of FIG. 7, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to an optical signal amplifier (a praseodymium doped fiber amplifier (PDFA)) and a method of designing the optical signal amplifier. The praseodymium doped fiber amplifier includes a silica glass optical fiber with a length selected from a range of 5 m to 26 m, a core radius, and a doped inner layer. In some aspects, the silica glass optical fiber may have a length selected from the range of 15 m to 16 m, a core radius of 1.2 μm, and a doped inner layer. A concentration of praseodymium in the doped inner layer is 50×10²⁴ ions/m³. Performance of the PDFA is evaluated by considering a defined length of Pr³⁺ doped fiber, concentration of Pr³⁺ ions and pump power. The impact of input signal wavelength on gain, amplified spontaneous emission (ASE) noise, and noise figure (NF) of the amplifier is described. A small-signal peak gain of around 22.7 dB is achieved at 1.3 μm for Pr³⁺ doped fiber with a short length of 15.7 m at an optimized pump power of 300 mW.

In various aspects of the disclosure, non-limiting definitions of one or more terms that will be used in the document are provided below.

The term “gain medium” refers to a material that has quantum properties to amplify laser beams through a process of stimulated emission. The gain medium is a source of optical gain within a laser device which results from emission of molecular or electronic transitions from a higher energy state to a lower energy state.

The term “amplified spontaneous emission” (ASE) refers to light produced either by spontaneous emission or light that has been optically amplified by the process of stimulated emission in a gain medium.

The term “optimized parameter” is defined as a parameter at which an optical signal amplifier yields a highest gain. In an example, the optimized parameter may be an optimized length, an optimized pump power or an optimized dopant (Pr³⁺) concentration.

The term “about” refers to a small variation around a specified measurement. For example, “about 50×10²⁴ ions/m³” is indicates a doping concentration within a range of 45×10²⁴ ions/m³ to 55×10²⁴ ions/m³, a length of “about 15.7 m” indicates a preferred length within a range of 15 m to 16 m, a gain of “about 20.4 dB” indicates a gain in a range of 19.8 dB to 21 dB, a core radius of “about 1.2 μm” indicates a core radius within a range of 1.17 μm to 1.23 μm, a pumped laser beam of “about 1.3 μm” indicates a range of 1.27 μm to 1.33 μm, a pumped power of “about 300 mW” indicates a pumped power in the range of 290 mW to 310 mW, and the like.

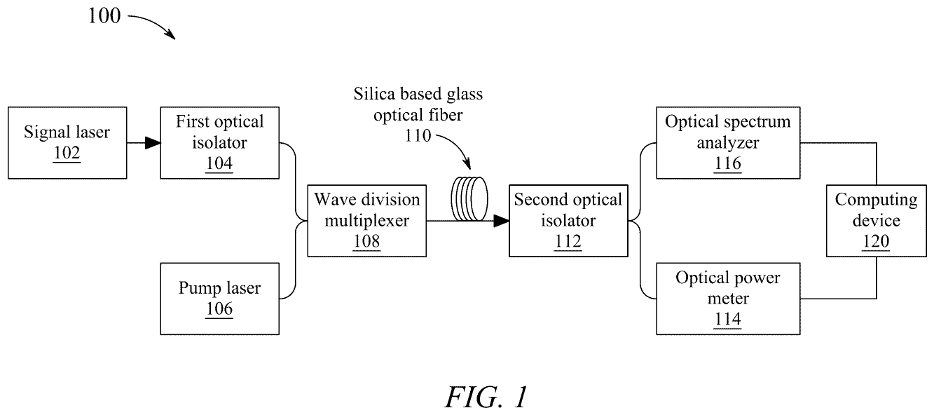

FIG. 1 is a schematic diagram of an optical signal amplifier 100, according to aspects of the present disclosure. As shown in FIG. 1, the optical signal amplifier 100 (hereinafter referred to as “amplifier 100”) includes various components such as a signal laser 102, a first optical isolator 104, a pump laser 106, a wave division multiplexer 108, a silica based glass optical fiber 110, a second optical isolator 112, an optical power meter 114, an optical spectrum analyzer (OSA) 116 and a computing device 120. In an aspect, amplifier 100 is a praseodymium doped fiber amplifier (PDFA) 100.

The signal laser 102 is configured to generate a signal laser beam of wavelength of 1.3 μm. In an aspect, the signal laser 102 may be a feedback laser, a non-feedback laser, an Nd:YAG laser, a CO₂ laser, a Nd:YVO₄ laser, and a green laser. In some examples, the signal laser 102 (transmitting optics) includes inter alia, such as a neodymium-doped yttrium aluminum garnet (Nd:YAG) laser, an optical attenuator, a Gallilean beam expander, a collimator, and a diffuser. In some examples, the signal laser 102 is a continuous-wave laser or a pulsed laser. The continuous-wave laser is configured to produce a continuous, uninterrupted beam of light, ideally with a very stable output power.

The first optical isolator 104 is connected to the signal laser 102. The first optical isolator 104 is configured to receive the generated signal laser beam from the signal laser 102 and generates an isolated signal laser beam. For example, the first optical isolator 104 is a passive magneto-optic device that only allows generated signal laser beam to travel in one direction. The first optical isolator 104 is configured to transmit the signal laser beam to the wave division multiplexer 108 and prevent the signal laser beam from reflecting back into the signal laser 102.

It is desirable that the signal laser beam of the signal laser 102 is optically isolated to prevent back reflections from damaging the signal laser 102 or causing undesirable optical interactions. The optical isolation is performed using an optical isolator through which the signal laser beam of the signal laser 102 is coupled. Therefore, the first optical isolator 104 is used to prevent back reflected light from returning to the signal laser 102. The first optical isolator 104 is configured to ensure the unidirectional operation of the signal laser 102. In an aspect, the first optical isolator 104 prevents unwanted feedback into an optical oscillator, such as a laser cavity. In some aspects, the first optical isolator 104 is configured to improve the isolation between the signal laser 102 (an optical source) and a transmission link in an optical communications system. The optical isolators (the first optical isolator 104 or the second optical isolator 112) are used for reducing the back reflections, which may affect the operation of the PDFA 100, and stabilizing the operation of the PDFA 100 by preventing it from reflected laser beam.

The pump laser 106 is configured to generate a pumped laser beam of 1.03 μm at a pumped power of about 300 mW. The pump laser 106 is configured to transfer energy from an external source into a gain medium of the PDFA 100. The transferred energy is absorbed by the gain medium, producing excited states in its atoms. When the number of particles in one excited state exceeds the number of particles in the ground state or a less-excited state, population inversion is achieved. Population inversion is a process of achieving greater population of higher energy state as compared to the lower energy state. The population inversion causes emission transitions from a laser upper level to a laser lower level. These emission transitions are transitions emitting photons in an intended wavelength band.

In an aspect, the pump laser 106 is selected from the group consisting of a continuous wave laser and a pulsed laser. In an example, the pump laser 106 is selected from the group consisting of a solid state laser, a Nd:YAG laser, a Nd:YLF laser, laser diodes, a semiconductor laser, and a cladding pump fiber.

The wave division multiplexer 108 is connected to the first optical isolator 104 and the pump laser 106. The wave division multiplexer 108 is configured to receive the isolated signal laser beam from the first optical isolator 104 and the pumped laser beam from the pump laser 106 simultaneously. The wave division multiplexer 108 is configured to combine the received signal laser beam and the pumped laser beam and generate a combined laser beam. In an example, the wave division multiplexer 108 is a dual-port WDM analyzer.

The silica based glass optical fiber (praseodymium doped silica fiber) 110 is configured to receive the combined laser beam from the wave division multiplexer 108. In a structural aspect, the silica based glass optical fiber 110 includes a core radius of about 1.2 μm and a doped inner layer. A doping concentration of the praseodymium doped silica based optical fiber 110 is selected from a range of 45×10²⁴ ions/m³ to 55×10²⁴ ions/m³. A preferred concentration of praseodymium Pr³⁺ ions in the doped inner layer is 50×10²⁴ ions/m³±1×10²⁴ ions/m³. For example, the silica based glass optical fiber 110 has a concentration of praseodymium ions in a doped inner layer of about 50×10²⁴ ions/m³. In an aspect, the silica based glass optical fiber 110 has a length selected from the range of 15 m to 16 m. For example, a preferred length of the praseodymium doped silica based optical fiber 110 is about 15.7 m.

The silica based glass optical fiber 110 is configured to amplify photons in the received laser beam and to generate an amplified laser beam. In an aspect, the PDFA 100 uses praseodymium ions as the gain medium. In an operative aspect, the PDFA 100 is placed at an optical transmitter side to enhance the power level of the optical signals to be transmitted and to generate amplified optical signals as output. The PDFA 100 is configured to amplify the signals so that the amplified (optical) signals can cover a large distance. Further, there may be various kinds of losses that occur in optical elements (for example, optical coupler, splitters, WDM multiplexers, and external optical modulators) between the laser and optical fibers. The PDFA 100 is configured to amplify the optical signals such that the amplified optical signal is able to compensate for such losses.

In an operative aspect, the gain medium of the PDFA 100 is pumped through the pump laser 106 operating at the wavelength of λₚ=1.03 μm and an optimized pump power of about 300 mW. In an aspect, an indirect pumping is employed to excite the Pr³⁺ ions in the gain medium of the wavelength of 1.03 μm. Since the indirect pumping at shorter wavelengths of 1.01 μm, 1.017 μm, 1.02 μm, 1.03 μm, etc., have been widely employed, the wavelength of 1.03 μm is selected as a suitable pump wavelength in the present PDFA 100. The Pr³⁺ ions are excited from the ground energy state to higher energy states by forward pumping the gain medium. The photons of the input optical signal (combined laser beam) that is to be amplified, having an emission wavelength of λₛ=1.3 μm, interact with the excited Pr³⁺ ions. This results in an increase in energy of the combined laser beam in the form of supplementary photons that are released as a result of stimulated emission of excited Pr³⁺ ions having an identical phase and frequency to the photons of the input signal.

The praseodymium Pr³⁺ ions of the silica based glass optical fiber 110 are configured to receive energy from signal photons of the combined laser beam and release an amount of supplementary photons. The released amount of the supplementary photons further amplifies the combined laser beam. In an aspect, the amount of the supplementary photons amplify the signal photons of the combined laser beam by a gain of about 20.4 dB. In an example, the supplementary photons have the same phase and the same frequency as the signal photons.

The second optical isolator 112 is configured to receive the amplified laser beam from the silica based glass optical fiber 110. The second optical isolator 112 generates an isolated amplified laser beam. The second optical isolator 112 is configured to ensure unidirectional operation of the amplified laser beam. The second optical isolator 112 is configured to transmit the amplified laser beam to the OSA 116 and the optical power meter 114. The second optical isolator 112 is configured to prevent the amplified laser beam from reflecting back into the silica based glass optical fiber 110. In an aspect, the amplified laser beam exiting the PDFA 100 has a wavelength in the range of 1.25 μm to 1.35 μm.

The second optical isolator 112 may transmit or transfer the amplified laser beam to downstream components of an optical transmission system. The optical spectrum analyzer 116, the computing device 120 and the optical power meter may be configured as intermediary measuring devices which can be monitored by an operator. Measurements generated by the computer may be transmitted to a remote station, for monitoring and error control.

The optical power meter 114 is commutatively connected to the second optical isolator 112 and receives the isolated amplified laser beam from the second optical isolator 112. The optical power meter 114 is configured to measure an amplitude of the received amplified laser beam. In an aspect, the optical power meter 114 is used to measure an optical power of the optical energy passing along the silica based glass optical fiber 110. In some examples, the optical power meter 114 includes a tapping means (for example, a beam splitter, a WDM coupler, an optocoupler) for tapping optical radiation from the silica based glass optical fiber 110, a transducer for converting the tapped optical radiation into an electrical signal, and a display unit for displaying the amplified signal.

The OSA 116 is connected to the second optical isolator 112. The OSA 116 is configured to receive the isolated amplified laser beam from the second optical isolator 112. The OSA 116 is configured to measure a frequency response of the received amplified laser beam. The OSA 116 is configured to measure the spectrum content of the received laser beam. The OSA 116 is further configured to measure and display the distribution of power of the signal laser 102 over a specified wavelength span. In an aspect, the OSA 116 is configured to display power on the vertical scale and the wavelength on the horizontal scale.

The computing device 120 is connected to the OSA 116 and the power meter 114. The computing device is configured to calculate a noise figure (NF) of the amplified laser beam from the calculated amplitude and frequency response of the amplified laser beam. The NF of an optical amplifier (e.g., a fiber amplifier or semiconductor optical amplifier) is a measure of how much excess noise the amplifier adds to the signal. More precisely, NF is a factor which indicates how much higher the noise power spectral density of the amplified output as compared with the input noise power spectral density. In an aspect, the NF is in the range of 5.6 dB to 5.9 dB for an input signal power of 0 dB to −32 dBm. In some aspects, the NF varies linearly with the signal wavelength.

In an operative aspect, a first length of the praseodymium (Pr³⁺) doped silica based optical fiber 110 having a first Pr³⁺ ion concentration is selected and the combined laser beam (a combination of the pump laser beam and the signal laser beam) is injected into the Pr³⁺ doped silica based optical fiber 110. The combined laser beam excites the Pr³⁺ ions of the Pr³⁺ doped silica based optical fiber 110. The excited Pr³⁺ ions release the supplemental photons which amplify the combined laser beam and generate an amplified laser beam at an output of the Pr³⁺ doped silica based optical fiber 110. The optical power meter 114, connected to the output of the Pr³⁺ doped silica based optical fiber 110, measures the amplitude of the amplified laser beam. The OSA 116, connected to the Pr³⁺ doped silica based optical fiber 110, measures the frequency response of the amplified laser beam.

The computing device 120, connected to the optical power meter 114 and the OSA 116, generates a first noise figure and a first gain measurement of the optical signal amplifier 100 having the first length of the praseodymium (Pr³⁺) doped silica based optical fiber 110. The computing device 120 is configured to store the first noise figure and the first gain with the first length in a memory of the computing device 120. Further, the first length of Pr³⁺ doped silica based optical fiber 110 is replaced with a second length of Pr³⁺ doped silica based optical fiber. The combined laser beam (a combination of the pump laser beam and the signal laser beam) is injected into the second length of Pr³⁺ doped silica based optical fiber 110. The combined laser beam excites the Pr³⁺ ions of the Pr³⁺ doped silica based optical fiber 110. The excited Pr³⁺ ions release the supplemental photons which amplify the combined laser beam and generate an amplified laser beam at an output of the Pr³⁺ doped silica based optical fiber 110. The optical power meter 114, connected to the output of the Pr³⁺ doped silica based fiber, measures the amplitude of the amplified laser beam. The OSA 116, connected to the Pr³⁺ doped silica based optical fiber 110, measures the frequency response of the amplified laser beam. The computing device 120 is configured to calculate a second noise figure and a second gain of the optical signal amplifier 100 having the second length and store the second noise figure and a second gain with the second length in the memory. In an aspect, the second length is greater than the first length

The PDFA 100 is configured to calculate the noise figure and the gain for successive lengths of Pr³⁺ doped silica based fibers until a reduced current gain as compared with a previous gain is achieved. Further, a current noise figure is achieved that is more with respect to a directly previous noise figure. The computing device 120 compares the successive lengths to determine a length which generates a first maximum gain of the signal laser beam. In an aspect, the PDFA 100 is configured to vary a praseodymium doping concentration of the praseodymium doped silica based fiber having the length which generates the first maximum gain of the signal laser beam. The PDFA 100 injects the combined pump laser beam and signal laser beam for each praseodymium doping concentration and determines the praseodymium doping concentration which generates a second maximum gain of the signal laser beam. After that, the PDFA 100 is configured by installing the length of praseodymium doped silica based fiber having the second maximum gain of the signal laser beam in a fiber receptacle of the PDFA 100.

In an aspect, the maximum gain of the PDFA 100 is in a range of 15 dB to 23 dB.

The following examples are provided to illustrate further and to facilitate the understanding of the present disclosure.

The following experiments demonstrate a performance evaluation of the PDFA 100 operating in a range of 1.25 μm-1.35 μm of wavelength based on theoretical simulation. The performance of the PDFA 100 was evaluated by considering an optimized length of Pr³⁺ doped silica based optical fiber 110, the concentration of Pr³⁺ ions and the pump power. The impact of input signal wavelength on gain, amplified spontaneous emission (ASE) noise, and noise figure (NF) of the PDFA 100 were studied. In an example, a small-signal peak gain of around 22.7 dB was achieved at 1.3 μm for Pr³⁺ doped fiber with a length of 15.7 m at an optimized pump power of 300 mW. Also, a minimum NF of 4 dB was observed at 1.284 μm.

To evaluate the performance of the PDFA 100, the fiber length, doping concentration, pump power, signal power, core diameter, numerical aperture (NA), and mode field diameter (MFD) were measured and analyzed. All measured and analyzed parameters are summarized in Table 1.

TABLE 1
Details of important parameters

| Sr. No. | Parameters | Value | |
|---|---|---|---|
| 1 | Signal wavelength | 1.3 | μm |
| 2 | Pumping wavelength | 1.03 | μm |
| 3 | Optimized pump power | 300 | mW |
| 4 | Core radius | 1.2 | μm |
| 5 | Doping radius | 1.2 | μm |
| 6 | Numerical aperture (NA) | 0.26 | |
| 7 | Mode-field diameter (MFD) | 4 | μm |
| 8 | Signal attenuation | 0.1 | dB |
| 9 | Pump attenuation | 0.15 | dB |
| 10 | Temperature | 300 | K |

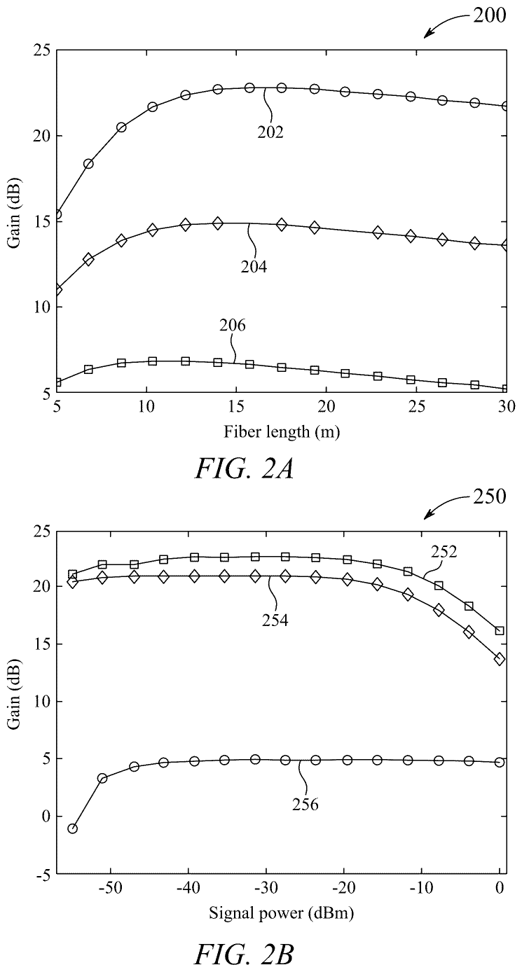

FIG. 2A is a graph 200 illustrating the gain of the PDFA 100 versus praseodymium doped fiber (PDF) length at different pump powers. The evolution of the gain of the PDFA 100 was observed by varying the length of the PDF 110 at different pump powers when the doping concentration of Pr³⁺ ions was 50×10²⁴ ions m⁻³, as shown in FIG. 2A. Curve 202 represents the gain of the PDFA 100 when the pump power was 300 mW. Curve 204 represents the gain of the PDFA 100 when the pump power was 200 mW. Curve 206 represents the gain of the PDFA 100 when the pump power was 100 mW. It can be observed that the PDFA 100 exhibits the highest gain equal to 22.7 dB for a 15.7 m length of PDF while using the pump power of 300 mW. A decreasing trend in gain was observed after further increasing the length of PDF which was due to a decrease in population inversion. Therefore, the PDF length of 15.7 m was selected as the optimized length which yields the highest gain.

FIG. 2B is a graph 250 illustrating the effect of different Pr³⁺ ion concentrations on the gain of the PDFA 100. FIG. 2B shows the gain versus input signal power at different concentrations of Pr³⁺ ions for PDF length and pump power of 15.7 m and 300 mW, respectively. Curve 252 represents the gain of the PDFA 100 when the concentration of Pr³⁺ ions was 50×10²⁴ ions m⁻³. Curve 254 represents the gain of the PDFA 100 when the concentration of Pr³⁺ ions was 150×10²⁴ ions m⁻³. Curve 256 represents the gain of the PDFA 100 when the concentration of Pr³⁺ ions was 5×10²⁴ ions m⁻³. It may be observed that the peak gain is obtained when the doping concentration of Pr³⁺ ions was 50×10²⁴ ions m⁻³.

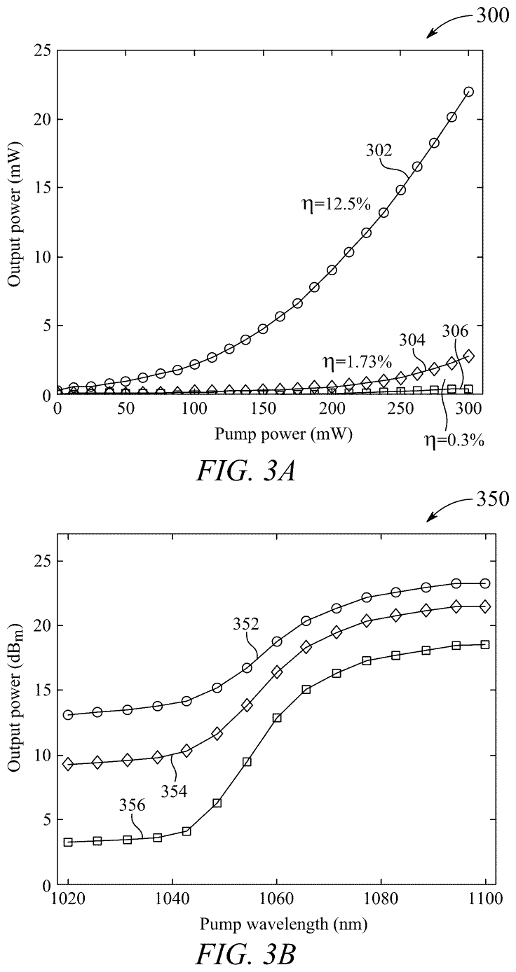

FIG. 3A is a graph 300 illustrating pump power versus output power of the PDFA 100 at different signal powers. Curve 302 represents the output power of the PDFA 100 when the signal power was 0 dBm. Curve 304 represents the output power of the PDFA 100 when the signal power was 16 dBm. Curve 306 represents the output power of the PDFA 100 when the signal power was 32 dBm.

The power conversion efficiency (PCE) n of a doped fiber amplifier can be written as:

$$P C E ( \% ) = \frac{{P}_{{s}_{out}} - {P}_{{s}_{in}}}{{P}_{p}} \qquad ( 1 )$$

where Pₛᵢₙ, PSₒᵤₜ, and Pₚ are the powers of the input signal, the amplified signal, and the pump, respectively. To estimate the PCE of the PDFA 100, the pump power versus output power was plotted, as shown in FIG. 3A, where the output power is a function of the input signal power for PDF length and Pr³⁺ ions concentration of 15.7 m and 50×10²⁴ ions m⁻³, respectively. It is reflected in FIG. 3A that the maximum value of PCE equal to 12.5% is obtained at an input signal power of 0 dBm (shown by curve 302) while its minimum value of 0.3% is obtained for an input signal power of −32 dBm (shown by curve 306).

FIG. 3B is a graph 350 illustrating pump wavelength versus output power of the PDFA 100 for an input signal power of 0 dBm at different pump powers. Curve 352 represents the output power of the PDFA 100 when the pump power was 300 mW. Curve 354 represents the output power of the PDFA 100 when the pump power was 200 mW. Curve 356 represents the output power of the PDFA 100 when the pump power was 100 mW. The effect of the variation of pump wavelength on the output power of the amplifier was investigated, as shown in FIG. 3B. It was noticed that for the wavelength range of 1.02 μm-1.075 μm, the output power starts increasing from values of 3.5 dBm, 10 dBm, and 14 dBm up to 17.3 dBm, 20.3 dBm, and 22.2 dBm for pump powers of 100 mW, 200 mW, and 300 mW, respectively. For the wavelength range of 1.075 μm to 1.08 μm, the output power increases very slowly for each of the three pump power values.

For wavelengths beyond 1.08 μm, a saturation region starts where the output power does not increase significantly for the three values of pump powers, as shown in FIG. 3B. The plots of FIG. 3B may be explained by considering the absorption and emission spectra of Pr³⁺ ions. It is evident that the absorption spectrum of Pr³⁺ ions lies in the 0.96 μm-1.08 μm wavelength range. Beyond the wavelength of 1.08 μm, there is a gradual decrease in the absorption of pump photons, resulting in a decrease in the gain provided by the PDFA 100.

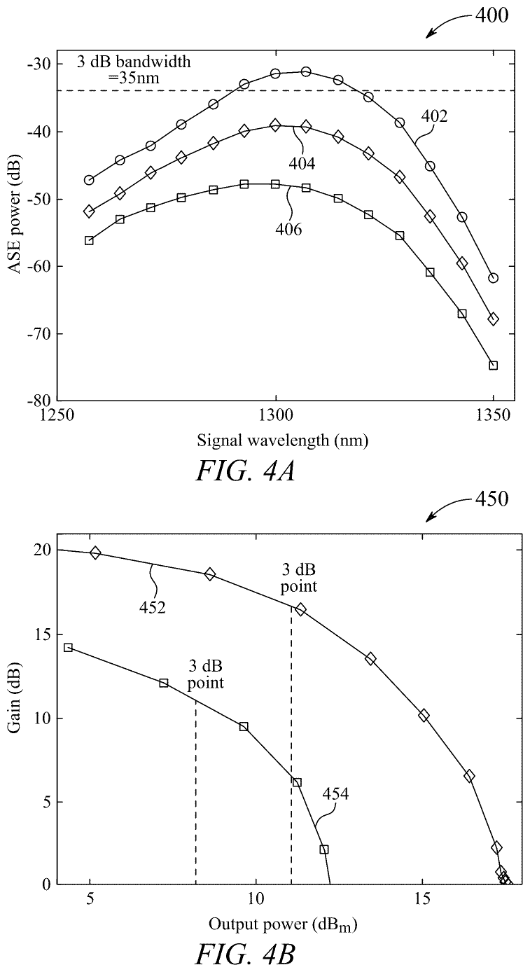

FIG. 4A is a graph 400 illustrating the ASE power versus the pump power obtained at optimized PDF length and Pr³⁺ ions concentration. Curve 402 represents the ASE power of the PDFA 100 when the pump power was 100 mW. Curve 404 represents the ASE power of the PDFA 100 when the pump power was 200 mW. Curve 406 represents the ASE of the PDFA 100 when the pump power was 300 mW. It is evident that the ASE peak power is around-48 dBm at a pump power of 100 mW (shown by curve 402) and becomes −38 dBm at 200 mW (shown by curve 404) of the pump power.

The highest ASE peak power of around −31 dB was obtained at 1.3 μm when the pump power was 300 mW (shown by curve 406). It is also evident that at higher wavelengths, the PDFA 100 exhibits a decreasing trend in ASE noise power which is due to the impact of ground state absorption (GSA) using the pump laser at higher wavelengths due to poor inversion. Moreover, 3 dB ASE bandwidth of 35 nm is obtained when the pump power was 300 mW.

To find the saturated optical power of the PDFA 100, gain versus the output optical power plots of the PDFA 100 are obtained at different pump powers, as shown in FIG. 4B. Curve 452 represents the gain of the PDFA 100 when the pump power was 300 mW. Curve 454 represents the gain of the PDFA 100 when the pump power was 200 mW. Saturated output optical power of 8 dBm and 11 dBm were obtained corresponding to 3 dB for 200 mW and 300 mW pump powers, respectively.

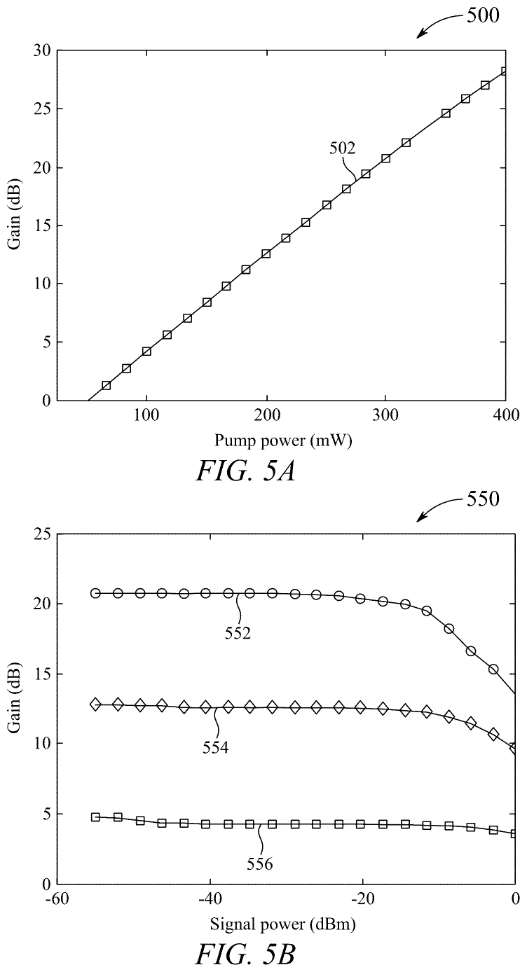

FIG. 5A is a graph 500 illustrating the gain of the PDFA 100 versus the pump power at obtained optimized parameters. The relationship between the gain of the PDFA 100 and the pump power is investigated by plotting the gain versus pump power at the optimized parameters, as shown in FIG. 5A. It is evident that the gain of the PDFA 100 increases by increasing the pump power. Curve 502 represents the gain of the PDFA 100 at the optimized parameters. FIG. 5B is a graph 550 illustrating the gain of the PDFA 100 versus the input signal power as a function of the pump power at optimized parameters. Curve 552 represents the gain of the PDFA 100 when the pump power was 300 mW. Curve 554 represents the gain of the PDFA 100 when the pump power was 200 mW. Curve 556 represents the gain of the PDFA 100 when the pump power was 100 mW. It may be observed that the lowest gain of 5 dB was achieved at an input signal power of −30 dBm. The highest gain of around 21 dB was obtained around input signal power of −30 dBm. On further increasing the power, a sharp decreasing trend in the gain of the PDFA up to the lowest value of 13 dB has been observed. The reason behind this trend is that there are a greater number of atoms in lower energy level as compared to an excited energy state.

The noise figure (NF) is one of the most important factors used in the characterization of optical amplifiers. NF of an optical amplifier is defined as the ratio of input signal-to-noise ratio (SNRᵢₙ) to the output signal-to-noise ratio (SNRₒᵤₜ) and usually is expressed in dB. The NF is given by:

$$N F = 10 {log}_{10} \frac{S N {R}_{in}}{S N {R}_{out}} \qquad ( 2 )$$

During the optical amplification of input signal by the PDFA 100, the ASE noise is generated in the form of photons as spontaneous emission is added to the signal photons. The ASE noise accumulates with the input signal and reduces the signal-to-noise ratio (SNR) of the amplified signal. Therefore, NF is an important parameter that can efficiently measure the reduction in the SNR of the PDFA 100. Typically, the ASE noise boosts abruptly in a case when the input signal is weak.

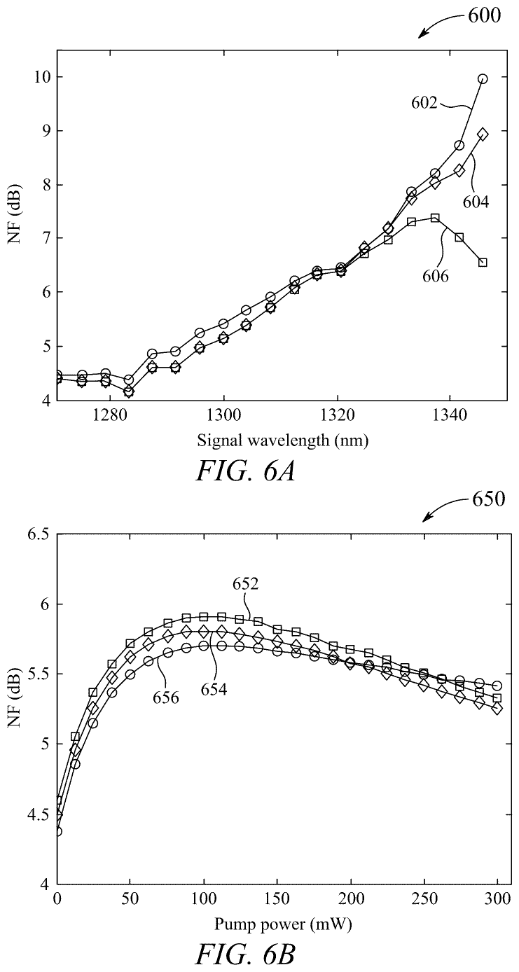

FIG. 6A is a graph 600 illustrating the NF versus the input signal wavelength at different signal powers. The NF of around 5.1 dB, 5.1 dB, and 5.5 dB were obtained at wavelength of 1.3 μm at signal powers of −32 dBm, −16 dBm, and 0 dBm, respectively as shown in FIG. 6A.

Curve 602 represents the ASE power of the PDFA 100 when the signal power was 0 dBm. Curve 604 represents the ASE power of the PDFA 100 when the signal power was −16 dBm. Curve 606 represents the ASE power of the PDFA 100 when the signal power was −32 dBm. It may be noticed that a minimum NF of around 4 dB was observed at 1.284 μm corresponding to signal powers of −32 dBm and −16 dBm. At the same value of the input signal wavelength, NF of around 4.4 dB has been obtained when the signal power was 0 dBm.

FIG. 6B is a graph 650 illustrating NF of the PDFA 100 versus the pump power at different signal power. Curve 652 represents the NF of the PDFA 100 when the signal power was −32 dBm. Curve 654 represents the NF of the PDFA 100 when the signal power was −16 dBm. Curve 656 represents the NF of the PDFA 100 when the signal power was 0 dBm. It may be noticed that the minimum value of NF obtained is around 4.5 when the pump power was 0 mW at signal powers of −32 dBm, −16 dBm and 0 dBm. The minimum value of NF is achieved when the pump power is 0 mW, there is a negligible amount of ASE which results into a high optical signal-to-noise ratio (OSNR). The values of NF start increasing linearly with the pump power up to 100 mW at signal powers of −32 dBm, −16 dBm and 0 dBm due to an increase in amplification as well as ASE. Therefore, the maximum and minimum values of NFs obtained at 100 mW of pump power were around 5.9 dB and 5.6 dB for the input signal power of −32 dBm and 0 dBm, respectively. Furthermore, the reason behind slightly higher NF at signal power of −32 dBm as compared to 0 dBm is that the input signal of power −32 dBm has 0 SNR already degraded which results into an increase in NF.

The performance of the present PDFA 100 is compared with the aforementioned existing amplifiers and is summarized in Table 2. It is observed from the Table 2 that the present PDFA 100 is efficient in comparison to conventional optical amplifiers.

TABLE 2
Summary of performance comparison

| | Wave- | | | Pr³⁺ con- | Doped | Core |
|---|---|---|---|---|---|---|
| | length | Gain | NF | centration | length | diameter |
| Study | (μm) | (dB) | (dB) | (ions m⁻³) | (m) | (μm) |
| Jiang | 1.3 | 20 | — | 6 × 10²⁴ | 7 | 5 |
| Schimmel et al. | 1.3 | 15 | — | — | 14 | — |
| Chorchos et al. | 1.31 | 20.4 | 7 | — | — | — |
| Nishida et al. | 1.3 | 30 | 6.5 | — | 12 | 1.2 |
| The present | 1.3 | 22.7 | 4 | 50 × 10²⁴ | 15.7 | 1.2 |
| PDFA 100 | | | | | | |

The performance of the PDFA 100 is evaluated and demonstrated using the simulation results. In an aspect, the PDFA 100 is evaluated using an optiSystem software tool (developed by Optiwave Systems Inc., located at 7 Capella Court, Suite 300, Ottawa, ON, Canada, K2E 8A7). The optiSystem enables a user to plan, test, and simulate (in both the time and frequency domain). The optiSystem has been used to simulate a high-performance optical amplifier by optimizing the Pr³⁺ doped fiber length and the pump power under optimized dopant concentration. The results show that a peak gain of around 22.7 dB for the input signal wavelength of 1.3 μm is achieved at an optimized length of praseodymium doped fiber of around 15.7 m when pumped with an optimized power of 300 mW. The minimum NF of 4 dB is obtained at input signal wavelength of 1.284 μm corresponding to signal powers of −32 dBm and −16 dBm. It may be observed from Table 2 that Nishida et al. demonstrates a gain of 30 dB. Nishida et al. uses a fluoride-based fiber where Pr³⁺ ions were doped. In contrast, the optical signal amplifier of the disclosure uses a silica glass fiber. The absorption and emission spectra of Pr³⁺ ions behave differently in the fluoride host than in silica glass. Similarly, the transmission characteristics of optical signals alter in fluoride. Furthermore, Nishida et al. employed a dual-stage pumping to achieve higher gain while the optical signal amplifier as disclosed employed a single forward pump source to obtain a gain of 22.7 dB.

The first embodiment is illustrated with respect to FIG. 1-FIG. 6. The first embodiment describes the optical signal amplifier 100. The optical signal amplifier 100 includes a signal laser 102, a first optical isolator 104, a pump laser 106, a wave division multiplexer 108, a silica based glass optical fiber 110, a second optical isolator 112, an optical power meter 114, and an optical spectrum analyzer (OSA) 116. The signal laser 102 is configured to generate a signal laser beam of wavelength 1.3 μm. The first optical isolator 104 is connected to the signal laser 102. The pump laser 106 is configured to generate a pumped laser beam of 1.03 μm at a pumped power of 300 mW. The wave division multiplexer 108 is connected to the first optical isolator 104 and the pump laser 106. The wave division multiplexer 108 is configured to combine the signal laser beam and the pumped laser beam and generate a combined laser beam. The silica based glass optical fiber 110 has a concentration of praseodymium ions in a doped inner layer of 50×10²⁴ ions/m³. The silica based glass optical fiber 110 is configured to receive the combined laser beam, amplify photons in the combined laser beam, and generate an amplified laser beam. The second optical isolator 112 is configured to receive the amplified laser beam. The optical power meter 114 is connected to the second optical isolator, wherein the optical power meter 114 is configured to measure an amplitude of the amplified laser beam. The OSA 116 is connected to the optical isolator 114, wherein the OSA 116 is configured to measure a frequency response of the amplified laser beam.

In an aspect, the silica based glass optical fiber 110 has a length of 15.7 m and a core radius of 1.2 μm.

In an aspect, the silica based glass optical fiber 110 is configured to amplify the combined laser beam by a gain of 20.4 dB.

In an aspect, the first optical isolator 104 is configured to transmit the signal laser beam to the wave division multiplexer 108 and prevent the signal laser beam from reflecting back into the signal laser 102.

In an aspect, the second optical isolator 112 is configured to transmit the amplified laser beam to the OSA 116 and the optical power meter 114 and prevent the amplified laser beam from reflecting back into the silica based glass optical fiber 110.

In an aspect, the praseodymium Pr³⁺ ions are configured to receive energy from signal photons of the combined laser beam and release an amount of supplementary photons which amplify the photons in the combined laser beam.

In an aspect, the supplementary photons have a same phase and a same frequency as the signal photons.

In an aspect, the optical signal amplifier 100 includes a computing device 120 connected to the OSA 116 and the power meter 114, wherein the computing device 120 is configured to calculate a noise figure of the amplified laser beam from the amplitude and frequency response, wherein the noise figure is in the range of 5.6 dB to 5.9 dB for an input signal power of 0 dB to −32 dBm.

In an aspect, the noise figure varies linearly with the signal wavelength.

The second embodiment is illustrated with respect to FIG. 1-FIG. 6. The second embodiment describes a praseodymium doped fiber. The praseodymium doped fiber includes a silica based glass optical fiber having a length selected from the range of 15 m to 16 m, a core radius of 1.2 μm, and a doped inner layer, wherein a concentration of praseodymium Pr³⁺ ions in the doped inner layer is 50×10²⁴ ions/m³.

In an aspect, the length of the silica based glass optical fiber 110 is 15.7 m.

In an aspect, the silica based glass optical fiber 110 is configured to receive an input laser beam configured to excite the praseodymium Pr³⁺ ions to release an amount of supplementary photons which amplify the input laser beam.

In an aspect, the amount of supplementary photons are configured to amplify the signal photons of the input laser beam by a gain of 20.4 dB.

In an aspect, the supplementary photons have a same phase and a same frequency as the signal photons.

The third embodiment is illustrated with respect to FIG. 1-FIG. 6. The third embodiment describes a method of designing the optical signal amplifier 100. The method includes selecting a first length of a praseodymium (Pr³⁺) doped silica based fiber having a first Pr³⁺ ion concentration. The method includes performing the steps of: injecting the Pr³⁺ doped silica based fiber with a combined laser beam consisting of a pump laser beam and a signal laser beam, exciting the Pr³⁺ ions with the combined laser beam, releasing an amount of supplemental photons which amplify the combined laser beam from the excited Pr³⁺ ions, generating an amplified laser beam at an output of the Pr³⁺ doped silica based fiber, measuring, with an optical power meter 114 connected to the output of the Pr³⁺ doped silica based fiber, an amplitude of the amplified laser beam, and measuring, with an optical spectrum analyzer (OSA) 116 connected to the Pr³⁺ doped silica based fiber, a frequency response of the amplified laser beam. The method further includes calculating, with a computing device 120 connected to the optical power meter and the OSA 116, a first noise figure and a first gain of the optical signal amplifier 100 having the first length. The method further includes storing, in a memory of the computing device, the first noise figure and the first gain with the first length. The method further includes replacing the first length of Pr³⁺ doped silica based fiber with a second length of Pr³⁺ doped silica based fiber, wherein the second length is greater than the first length; and repeating the steps. The method further includes calculating, with the computing device, a second noise figure and a second gain of the optical signal amplifier having the second length and storing, in the memory, the second noise figure and a second gain with the second length. The method further includes repeating the steps for successive lengths of Pr³⁺ doped silica based fibers until a current gain decreases with respect to a directly previous gain and a current noise figure increases with respect to a directly previous noise figure. The method further includes comparing, by the computing device, the successive lengths to determine a length which generates a first maximum gain of the signal laser beam. The method further includes varying a praseodymium doping concentration of the praseodymium doped silica based fiber having the length which generates the first maximum gain of the signal laser beam. The method further includes injecting the optical signal amplifier with the combined pump laser beam and signal laser beam for each praseodymium doping concentration. The method further includes determining the praseodymium doping concentration which generates a second maximum gain of the signal laser beam. The method further includes installing the length of praseodymium doped silica based fiber having the second maximum gain of the signal laser beam in the optical signal amplifier.

The method further includes selecting the length from a range of 15 m to 16 m, and selecting the doping concentration of the praseodymium doped silica based optical fiber from a range of 45×10²⁴ ions/m³ to 55×10²⁴ ions/m³.

The method further includes pumping a pump laser beam at a pumped power of 300 mW, wherein the pump laser beam has a wavelength of 1.03 μm, generating a signal laser beam at a wavelength of 1.3 μm, and generating the combined laser beam by combining, by a wavelength division multiplexer, the pump laser beam and the signal laser beam.

In an aspect, a wavelength of the amplified laser beam exiting the optical signal amplifier is in the range of 1.25 μm to 1.35 μm.

In an aspect, the maximum gain of the amplifier 100 is in a range of 15 dB to 23 dB.

The method further includes the injecting the praseodymium doped silica based fiber with the combined laser beam excites the Pr³⁺ ions from the ground energy state to higher energy states, generating photons which interact with the combined pump laser beam and signal laser beam, wherein the photons have an identical phase and frequency of as the combined laser beam.

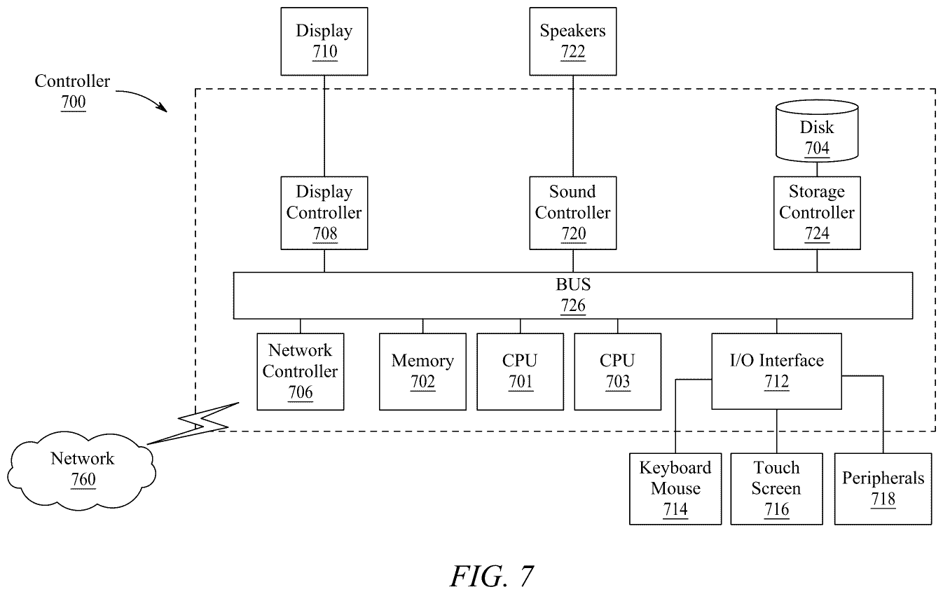

Next, further details of the hardware description of the computing environment according to exemplary embodiments is described with reference to FIG. 7. In FIG. 7, a controller 700 is described is representative of the computing device 120 which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 701, 703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 708, such as a NVIDIA Geforce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

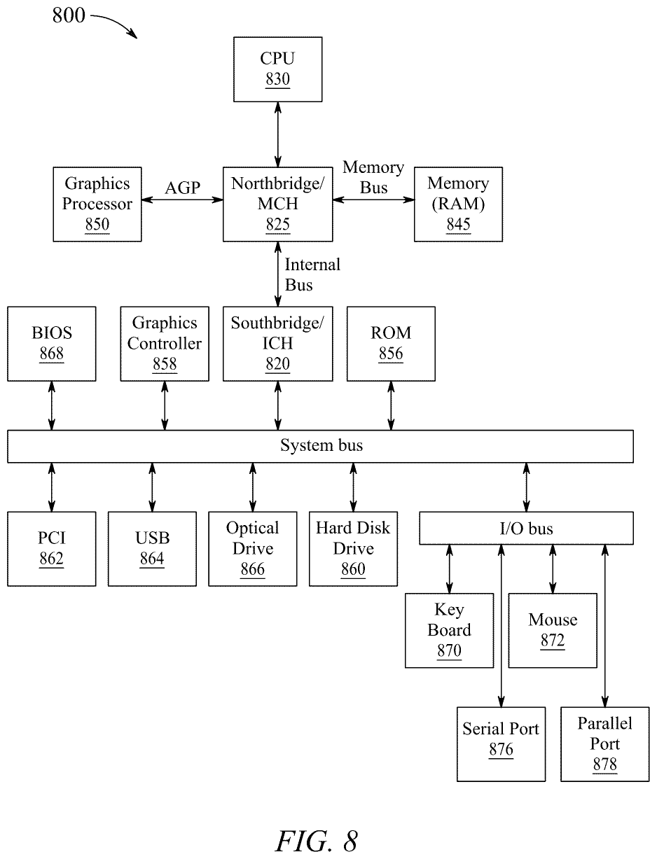

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

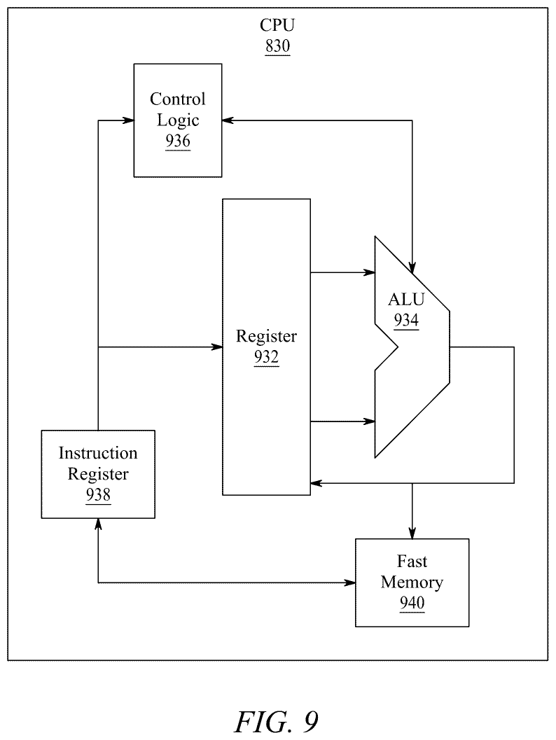

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

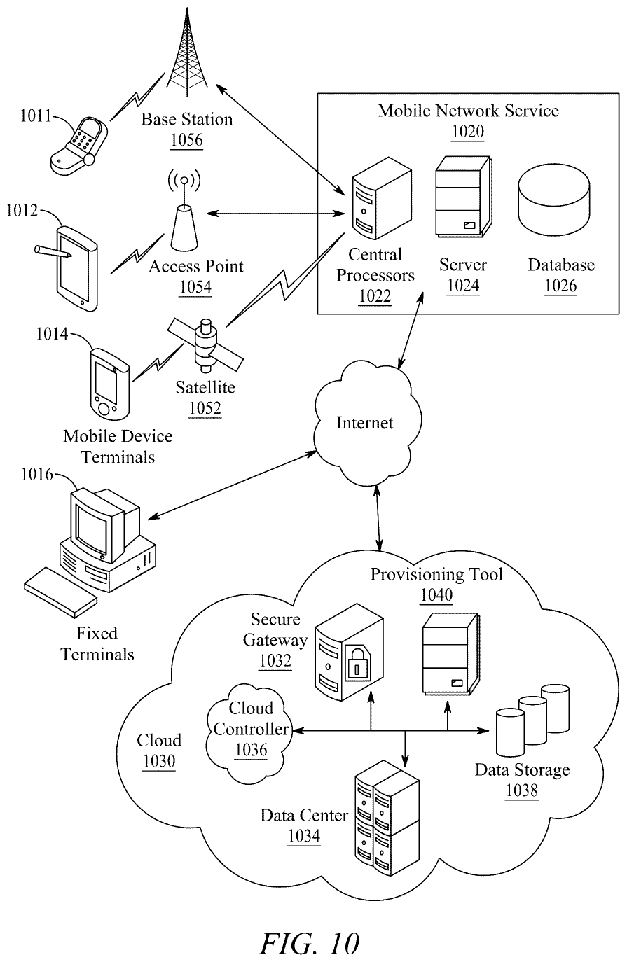

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 10, in addition to various human interface and communication devices (e.g., display monitors, smart phones, tablets, personal digital assistants (PDAs)). More specifically, FIG. 10 illustrates client devices including smart phone 1011, tablet 1012, mobile device terminal 1014 and fixed terminals 1016. These client devices may be commutatively coupled with a mobile network service 1020 via base station 1056, access point 1054, satellite 1052 or via an internet connection. Mobile network service 1020 may comprise central processors 1022, server 1024, and database 1026. Fixed terminals 1016 and mobile network service 1020 may be commutatively coupled via an internet connection to functions in cloud 1030 that may comprise security gateway 1032, data center 1034, cloud controller 1036, data storage 1038 and provisioning tool 1040. The network may be a private network, such as a LAN or WAN, or may be a public network, such as the Internet. Input to the system may be received via direct user input and received remotely either in real-time or as a batch process. Additionally, some aspects of the present disclosures may be performed on modules or hardware not identical to those described. Accordingly, other aspects of the present disclosures are within the scope that may be claimed.

The above-described hardware description is a non-limiting example of corresponding structure for performing the functionality described herein.

Obviously, numerous modifications and variations of the present disclosure are possible in light of the above teachings. It is therefore to be understood that within the scope of the appended claims, the invention may be practiced otherwise than as specifically described herein.

1-9. (canceled)

10. A praseodymium doped fiber, comprising:
a silica based glass optical fiber having a length in the range of 15 m to 16 m, a core radius of about 1.2 μm, and a doped inner layer, wherein a concentration of praseodymium Pr³⁺ ions in the doped inner layer is about 50×10²⁴ ions/m³.

11. The praseodymium doped fiber of claim 10, wherein the length is about 15.7 m.

12. The praseodymium doped fiber of claim 10, wherein the silica based glass optical fiber is configured to receive an input laser beam configured to excite the praseodymium Pr³⁺ ions to release an amount of supplementary photons which amplify the input laser beam.

13. The praseodymium doped fiber of claim 12, wherein the amount of supplementary photons are configured to amplify the signal photons of the input laser beam by a gain of about 20.4 dB.

14. The praseodymium doped fiber of claim 13, wherein the supplementary photons have a same phase and a same frequency as the signal photons.

15-20. (canceled)

21. A praseodymium doped fiber, comprising:
a silica glass optical fiber having a length of from 15 m to 16 m and a core radius of about 1.2 μm, and
praseodymium dispersed within the silica glass optical fiber;
wherein the silica glass optical fiber is doped with Pr³⁺ ions at a concentration of from 45×10²⁴ Pr³⁺ ions/m³ to 55×10²⁴ Pr³⁺ ions/m³.

22. The praseodymium doped fiber of claim 21, wherein the silica glass optical fiber consists of silica glass and Pr³⁺ ions at a concentration of 50× 10²⁴ ions m⁻³

23. The praseodymium doped fiber of claim 21, wherein the length is about 15.7 m.

24. The praseodymium doped fiber of claim 21, wherein the silica glass optical fiber is configured to receive an input laser beam configured to excite the praseodymium Pr³⁺ ions to release an amount of supplementary photons which amplify the input laser beam.

25. The praseodymium doped fiber of claim 24, wherein the amount of supplementary photons are configured to amplify the signal photons of the input laser beam by a gain of about 20.4 dB.

26. The praseodymium doped fiber of claim 25, wherein the supplementary photons have a same phase and a same frequency as the signal photons.
